(19) United States
(12) Patent Application Publication
(10) Pub. No.: US 2005/0128910 A1
(43) Pub. Date: Jun. 16, 2005

(54) METHOD FOR DETERMINING A THRESHOLD WRITE-IN POWER OF A COMPACT DISC AND RELATED COMPACT DISC DRIVE

(76) Inventors: Chang-Hui Lin, Taipei City (TW); Yu-Cheng Sung, Taipei City (TW); Pei-Yu Chiu, Tai-Chung City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,794

(22) Filed: Nov. 29, 2004

(30) Foreign Application Priority Data
Dec. 11, 2003 (TW) 092135015

(51) Int. Cl. G11B 5/09

(52) U.S. Cl. 369/47.53; 369/53.26

(57) ABSTRACT

A method for determining a threshold write-in power of a compact disc (CD) includes the following steps: (a) recording M test data into M sectors of an outer area of the CD with a pickup by emitting laser beams of a variety of distinct test powers, (b) reading the test data with the pickup and calculating corresponding error rates of the test data, and (c) comparing the M test powers and calculating the threshold write-in power, which is between an upper-bound test power and a lower-bound test power.

### BACKGROUND OF INVENTION

1. Field of the Invention

The present invention relates to a disc drive, and more particularly, to a method for determining a threshold write-in power of a compact disc, so that a pickup of the disc drive can record data onto a program area of the CD by emitting laser beams of a predetermined power smaller than the threshold write-in power.

2. Description of the Prior Art

In recent years, compact discs (CDs) have been developed to bring a variety of advantages to storage applications, such as compact size, low cost and large data-recording capacity. CDs are becoming one of the most popular data-storing media. Typically, a disc drive is used to record and access data on a CD.

Please refer to FIG. 1, which is a schematic diagram of a disc drive 10 capable of recording data onto a CD 20 according to the prior art. The CD 20 has a spiral track 22 progressing from the center outward and covered by a photoresist layer. In general, the CD 20 comprises a lead-in area 90, a program area 92 and a lead-out area 94. The disc drive 10 comprises a pickup 12 for accessing data of the CD 20. While the drive 10 writes data onto the CD 20, the pickup 12 makes the photoresist layer of the track 22 on the CD 20 be intermittently exposed to an on-and-off laser according to the data. The exposed photoresist layer of the track 22 will cause pits to form. On the contrary, the unexposed photoresist layer will be kept as lands. Reflections of the pits and the lands are not similar. In this way, different data (for example, digital “0” or “1”) can be represented by the pits and the lands respectively, and stored in the CD 20. While reading the data stored in the CD 20, the drive 10 can receive reflecting laser light from the CD 20 to read the data stored in the CD 20.

Please refer to FIG. 2. FIG. 2 is an enlarged plot according to a dashed line section of the CD 20 shown in FIG. 1. For a rewritable CD 20, its track 22 can be divided into two kinds of tracks, one is a data track 26 for recording data, and the other is a wobble track 28 for recording relative information of each frame on the CD 20. The data track 26 is an arc along the CD 20 and around the center of the CD 20, such as the track 22. Because FIG. 2 is an enlarged plot of a tiny part of the track 22, the data track 26 shown in FIG. 2 is a straight line. However, the wobble track 28 not only follows an arc along the CD 20 and around the center of the CD 20, as shown in FIG. 2, but also appears as sinusoidal with small amplitude along the track 22. The pickup 12 of the drive 10 can receive reflected light from the wobble track 28 to form a wobble signal. The disc drive 10 can detect which part of data on the CD 20 is being read by the pickup 12 based on the wobble signal.

According to the Orange Book regulating the specification of the CD 20, while the emitted laser power from the pickup 12 has optimal power, the reflected signal measured by the pickup 12 is an AC coupled high frequency (HF) signal with a perfect symmetrical amplitude. Please refer to FIG. 3 which shows a waveform of the HF signal reflected from the CD 20 while the pickup 12 of the disc drive 10 writes data onto the CD 20 based on an optimal write-in power, where the horizontal axis represents time, the vertical axis represents amplitude, and the place marked as level dc represents a corresponding amplitude of a long-term average of the waveform. If a laser is reflected from a pit, the HF signal shows an upper amplitude A1 over the level dc. If a laser is reflected from a land, the HF signal shows a lower amplitude A2 below the level dc. A measurement amplitude parameter β=(A1−A2)/(A1+A2) is for comparing the amplitudes A1 and A2.

During writing data into the CD 20, the disc drive 10 will encode the data, resulting in a total extended length of pits equaling to a total extended length of lands. In other words, a total spent time of the laser reflecting from pits and a total spent time of the laser reflecting from lands are the same, which causes a long-term average level dc of the reflected HF signal to be exactly in the middle of the upper amplitude A1 and the lower amplitude A2, that is β=0. If the laser power emitted from the pickup 12 is lower than the optimal power, if the laser-emitting time is too short or if the laser beam is not normal to the CD 20, insufficient extended pits result, which makes the waveform of the HF signal move downward and causes A1 to be less than A2, leading to β<0. On the contrary, if the laser power emitted from the pickup 12 is higher than the optimal power or if the laser-emitting time is too long, an over-length of an extended pit is formed, which makes the waveform of the HF signal move upward and causes A1 to be more than A2, leading to β>0. In other words, β represents an amount of the pits matching an amount of the lands during encoding. When β does not equal to 0, it means either the length of the pit or that of the land is incorrect, resulting in errors during encoding.

Besides β, a block error rate (BLER) and signal jitter in the duration of data-reading can also be used to judge a correction of data-writing. If there is something wrong when the CD 20 is written to, even between identical bits, the last times of signal-reading (that is, the extended length of the pits or the lands) are not the same, which increases the signal jitter. If a BLER generated by a processor 18 to calculate data read by the pickup 12 is larger than a threshold BLER equivalent to a data-decoding capability of the processor 18, the disc drive 10 can determine that the pickup 12 probably read incorrect data.

Please refer to FIG. 1 again. The disc drive 10 further comprises an absolute time in pregroove decoder (ATIP decoder) 14 for decoding the absolute time code acquired from the pickup 12, an eight-to-fourteen modulator (EFM) 16 for modulating the data into EFM data, and the processor 18 for calculating the BLER of data read by the pickup 12.

In general, an optimal power calibration (OPC) is processed on the lead-in area 90 of the CD 20 to calculate the optimal power Pₒₚₜ, regardless of whether the CD 20 is a CD-RW or a DVD-RW. The optimal power Pₒₚₜ increases according to the outward tracking of the pickup 12. The optimal power Pₒₚₜ ensures that the data recorded onto an inner circle of the CD 20 have a better quality. However, when the pickup 12 records data onto an outer circle of the CD 20, since an optimal power corresponding to the outer circle has a power level higher than that of the optimal power Pₒₚₜ of the inner circle, the CD 20 can become burned out due to the diversity of dye coated onto the CD 20 and improper writing strategy.

### SUMMARY OF INVENTION

It is therefore a primary objective of the claimed invention to provide a method for determining a threshold write-in power of a CD. A disc drive can therefore control a pickup to emit laser beams of a power less than the threshold write-in power onto the CD, so that data recorded onto a program area of the CD can be identified correctly by a processor without the possibility of burning out the CD.

According to the claimed invention, the method includes the following steps: (a) recording M test data onto M sectors of an outer area of the CD with a pickup by emitting laser beams of a variety of distinct test powers, (b) reading the M test data of the M sectors with the pickup and calculating M corresponding error rates of the M test data, and (c) comparing the M error rates and therefore calculating the threshold write-in power, which is smaller than a smallest test power in an upper-bound test power set consisting of a plurality of test powers whose corresponding error rates are all larger than a threshold error rate, and is larger than a largest test power in a lower-bound test power set consisting of a plurality of test powers whose corresponding error rates are all smaller than the threshold error rate.

According to the preferred embodiment, the threshold error rate relates a data-decoding capability of the processor. The stronger that the data-decoding capability of the processor is, the larger the threshold error rate becomes. Similarly so for the power of laser beams emitted by the pickup while recording data onto the program area of the CD.

According to the preferred embodiment, the outer area is located at a lead-out area of the CD. However, the outer area can be located at the end of the program area of the CD.

It is an advantage of the claimed invention that a method recording data onto the lead-out area of the CD and calculating the threshold write-in power before recording any data onto the program area of the CD can protect the CD from being burned out by laser beams of too great a power, without severely impacting the quality of data recorded onto the CD.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a disc drive accessing data of a CD according to the prior art.

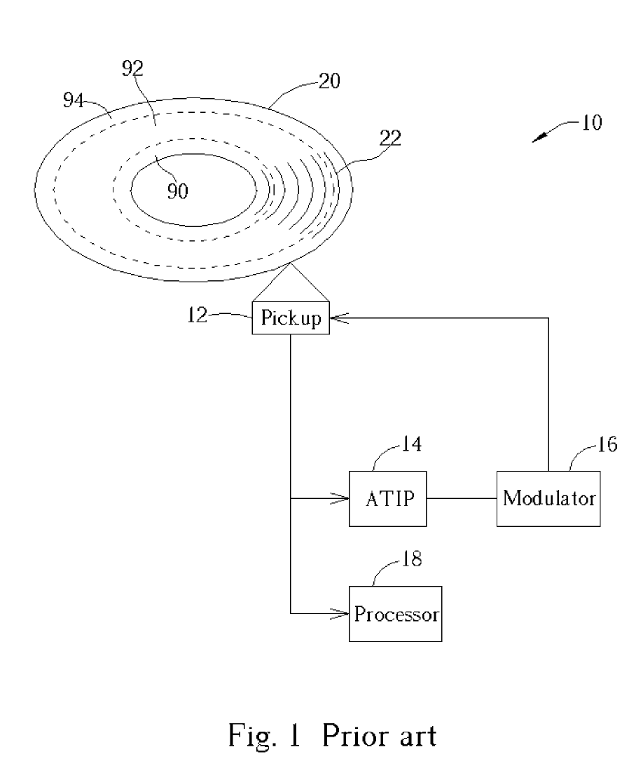

FIG. 2 is an enlarged plot according to a dashed line section of the CD shown in FIG. 1.

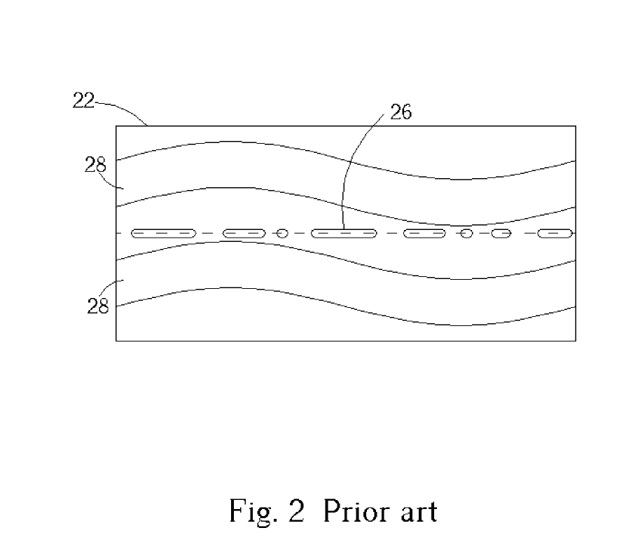

FIG. 3 is a waveform of a high frequency signal HF reflected from the CD when a pickup of the disc drive records data onto the CD by emitting laser beams of an optimal power according to the prior art.

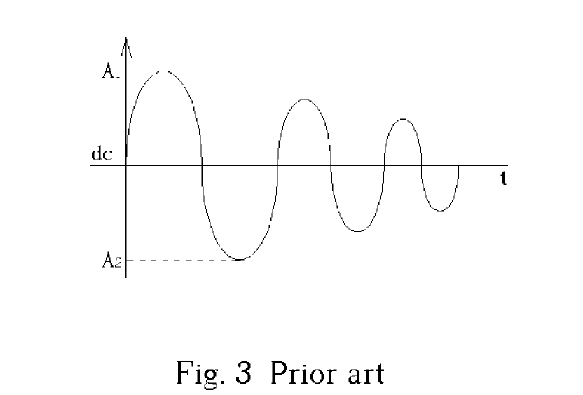

FIG. 4 is a schematic diagram of a disc drive accessing data of a CD of the preferred embodiment according to the present invention.

FIG. 5 is a flowchart of a method of the preferred embodiment according to the present invention.

FIG. 6 shows a relation between test power and corresponding BLER according to the present invention.

FIG. 7 shows a relation between test power and corresponding DC jitter value according to the present invention.

FIG. 8 is a schematic diagram showing a curve-fit of a plurality of data based on a multi-degree polynomial (Pₜₑₛₜ=2.3196*BLER²−749.2*BLER+60325) according to method of FIG. 5.

### DETAILED DESCRIPTION

After recording test data onto a lead-out area of a CD and determining a threshold write-in power of the CD, the method according to the present invention records data onto a program area of the CD with a pickup by emitting laser beams of a power less than the threshold write-in power, so as to protect the CD from being burned out.

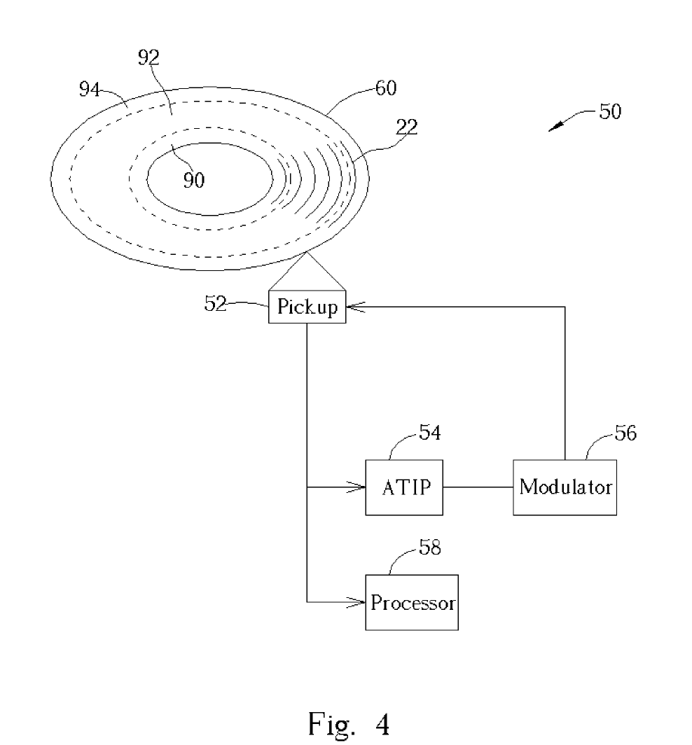

Please refer to FIG. 4, which is a schematic diagram demonstrating a disc drive 50 of the preferred embodiment accessing data of a CD 60 according to the present invention. The CD 60 can be a CD-R, a CD-RW, a DVD-RW, a DVD+R or a CD of any other type. The disc drive 50 comprises a pickup 52 for accessing data of the CD 60 by emitting/receiving laser beams onto/from the CD 60, an ATIP decoder 54 for decoding data read from the pickup 52, an EFM 56 for modulating data ready to be recorded onto the CD 60, and a processor 58 for processing data read from the pickup 52 and for calculating an error rate corresponding to the processed data. The processor 58 is capable of processing two types of error rates: one is a BLER, which defines how many parity inner code (PI) errors are contained in every eight consecutive ECCs of a CD, and the other is a DC jitter value, which defines a standard deviation between pits and lands.

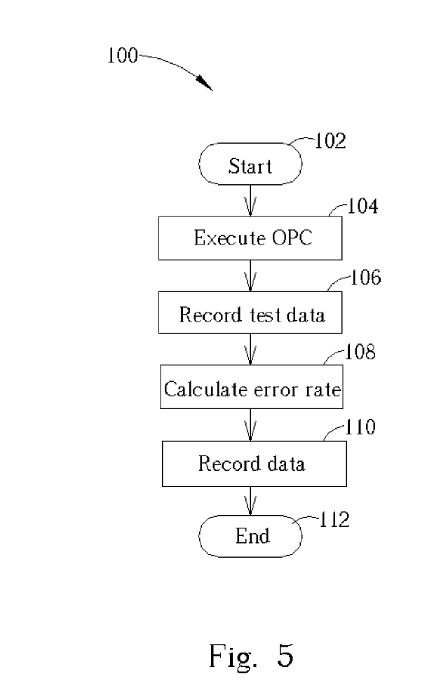

Please refer to FIG. 5, which is a flowchart of a method 100 of the preferred embodiment for determining a threshold write-in power Pₜₕ of the CD 60 according to the present invention. The method 100 comprises the following steps:

Step 102: Start;

(The CD 60 is placed on the disc drive 50.)

Step 104: Execute the OPC process on a lead-in area of the CD 60 and calculate an optimal power Pₒₚₜ;
Step 106: Record M test data onto M distinct sectors of a lead-out area of the CD 60 with the pickup 52 by emitting laser beams of a plurality of test powers Pₜₑₛₜ, each of which is greater than the optimal power Pₒₚₜ; (According to the preferred embodiment, the M test data are the same. However, any test data can be different from the remaining M−1 test data. Moreover, the pickup 52 can record the M test data onto the end of a program area instead of the lead-out area of the CD 60. Lastly, the M distinct test powers, which correspond to the M test data and are formed according to the optimal power Pₒₚₜ, can have values ranging from (1−25%)*Pₒₚₜ to (1+25%)*Pₒₚₜ. For example, if M is equal to 15 and the optimal power Pₒₚₜ is equal to 100 mW, a largest (the first) test power of the M1 test powers is equal to (1+25%)*100 mW=125 mW, a smallest (the last) test power of the M test powers is equal to (1−25%)*100 mW=75 mW and an nₜₕ test power of the M test powers is equal to

$$\frac{( n - 1 )}{( 15 - 1 )} * 50 mW + 75 mW . \text{)}$$

Step 108: Read the M test data recorded onto the M sectors of the CD 60 with the pickup 52 and calculate M BLERs corresponding to the M test data with the processor 58.

(The M BLERs corresponding to the M test data are used to demonstrate the method 100 of the present invention. Of course, the processor 58 can calculate M DC jitter values of the M test data instead of the M BLERs.)

Step 110: Compare the M BLERs and calculate the threshold write-in power Pₜₕ with the processor 58; and

(The threshold write-in power is smaller than a smallest test power P_{Ltest} in an upper-bound test power set consisting of a plurality of test powers whose corresponding BLERs are all larger than a threshold BLERₜₕ, and is larger than a largest test power P_{Stest} in a lower-bound test power set consisting of a plurality of test powers whose corresponding error rates are all smaller than the threshold BLERₜₕ. According to the preferred embodiment, the BLERₜₕ is equal to 100.)

Step 112: End.

(Therefore, the pickup 52 can be controlled to record data onto the CD 60 by emitting laser beams of predetermined powers, each of which is less than the threshold write-in power Pₜₕ, so as to protect the CD 60 from being burned out.)

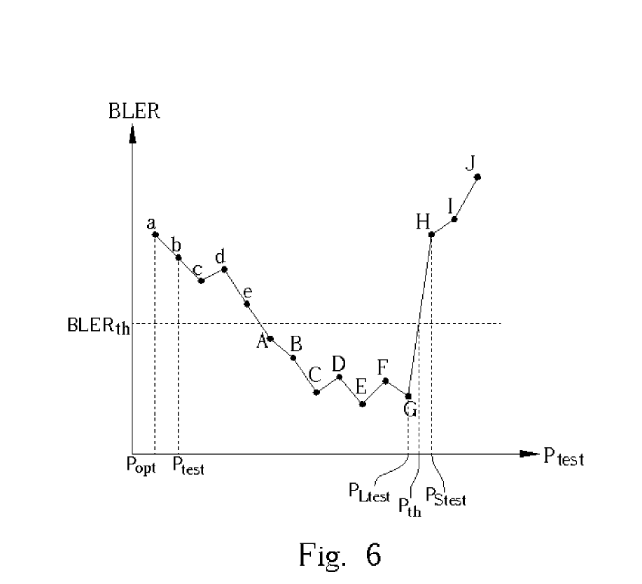

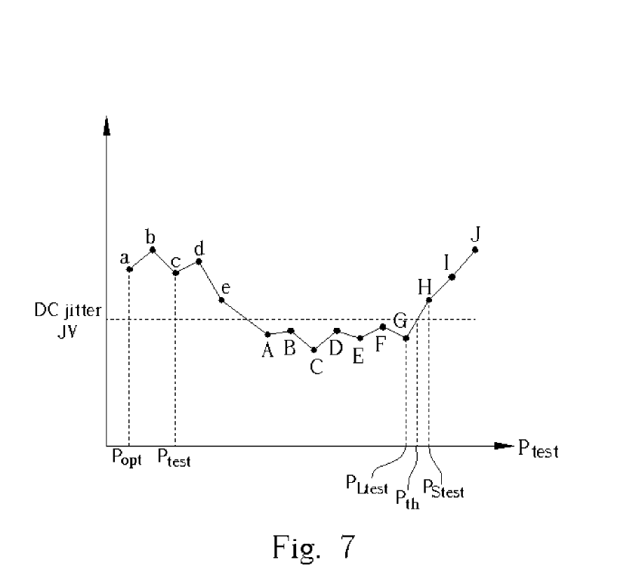

Please refer to FIG. 6 and FIG. 7. FIG. 6 shows a relation between test power and corresponding BLER according to the present invention, where the abscissa represents the test power, while the ordinate represents the BLER. FIG. 7 shows a relation between test power and corresponding DC jitter value according to the present invention, where the abscissa represents the test power, while the ordinate represents the DC jitter value. According to the FIG. 6 as well as FIG. 7, experiments show that as the test power increases, the BLER decreases below the threshold BLERₜₕ in the beginning and increases above the threshold BLERₜₕ gradually, and the DC jitter value decreases below a threshold DC jitter value JVₜₕ at first and increases above the threshold DC jitter value JVₜₕ gradually. Referring to FIG. 6, test powers Pₜₑₛₜ from A to C correspond to BLERs from A to G, all of which are smaller than the threshold BLERₜₕ. The lower-bound test power set consists of the test powers from A to C. The smallest test power P_{Ltest} is the test power C. On the contrary test powers Pₜₑₛₜ from H to J correspond to BLERs from H to J, all of which are larger than the threshold BLERₜₕ. The upper-bound test power set consists of the test powers from H to J. The largest test power P_{Stest} is the test power H. The threshold write-in power Pₜₕ is between the largest test power P_{Stest} and the smallest test power P_{Ltest}. Of course, the threshold write-in power Pₜₕ can be obtained by curve-fitting the M test powers based on a multi-degree polynomial consisting of test powers from A to J, whose independent variable is the BLER and whose dependent variable is the test power, the threshold write-in power Pₜₕ equal to the dependent variable while the independent variable is equal to the threshold BLERₜₕ. This is the reason why the plurality of test powers Pₜₑₛₜ in step 106 of the method 100 are formed according to the optimal power Pₒₚₜ*(1±25%). If a smallest test power of the test powers Pₜₑₛₜ is equal to the threshold write-in power Pₒₚₜ, a BLER corresponding to the smallest test power is probably larger than the threshold BLERₜₕ. All of the BLERs corresponding to the test power Pₜₑₛₜ will stay above the threshold BLERₜₕ, and the threshold BLERₜₕ corresponding to a certain data outside of a region consisting of a plurality of data and calculated by curve-fitting a multi-degree polynomial consisting of the plurality of data is probably wrong.

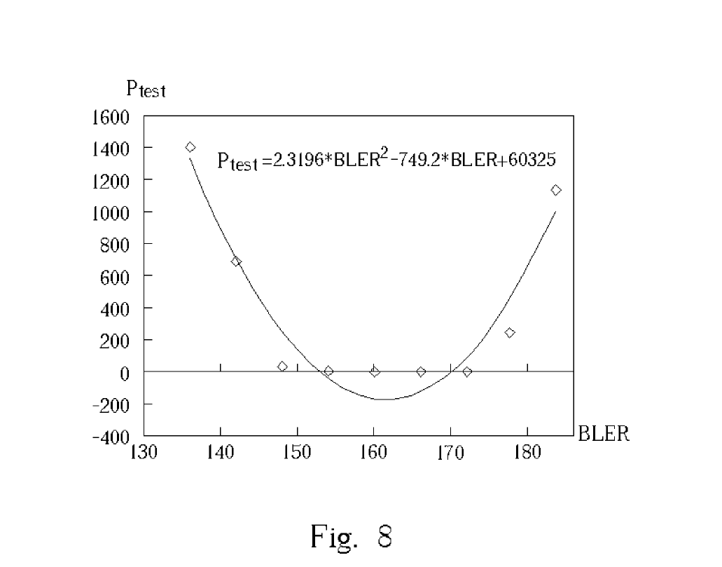

Please refer to FIG. 8, which is a schematic diagram showing a curve-fit of a plurality of data based on a multi-degree polynomial (Pₜₑₛₜ=2.3196*BLER²−749.2*BLER+60325) with EXCEL according to the present invention. From left to right, the plurality of data are (Pₜₑₛₜ, BLER)=(136, 1403), (142, 694), (148, 41), (154, 0), (160, 9), (166, 0), (172, 4), (178, 242) and (184, 1138).

Since a BLER corresponding to a recorded data is not smaller than the threshold BLERₜₕ unless the laser power for the pickup 52 to record the data onto an outer region (the lead-out area of the preferred embodiment) of the CD 60 is higher than the optimal power Pₒₚₜ, the M test data recorded onto the lead-out area of the CD 60 according to the plurality of test powers Pₜₑₛₜ starting from the optimal power Pₒₚₜ (step 106) comprises at least some BLERs corresponding to some initial data (from A to E in FIG. 6) larger than the threshold BLERₜₕ, the test powers from A to E hereby ignored in calculating the threshold write-in power Pₜₕ.

Since the lead-out area for the M test data to be recorded onto is located on an outer region of the CD 60, and the laser power for the pickup 52 to record data onto the outer region of the CD 60 is higher than that for the pickup 52 to recorded data onto an inner region of the CD 60, a laser power emitted by the pickup 52 onto the program area, an inner region in contrast to the outer region, will not burn out the CD 60 if the laser power is not higher than the threshold write-in power Pₜₕ.

FIG. 6 and FIG. 7 show that the BLER is more sensitive to the test power Pₜₑₛₜ than the DC jitter value JV.

The BLERₜₕ, as well as the JVₜₕ, the method 100 selects relates to the quality of data recorded onto the CD 60 and the data-encoding capability of the processor 58. In detail, if the processor 58 has a data-encoding capability good enough to encode the data recorded onto the CD 60 correctly, the BLERₜₕ that the data recorded onto the CD 60 can endure can have a higher value, and the laser beams projected onto the CD 60 can have a greater power level accordingly; On the contrary, if the processor 58 has a poor data-encoding capability, laser beams of a little power have a larger chance of burning out the CD 60, and the processor 58 therefore cannot encode the data recorded onto the CD 58 correctly.

In step 106 of the method 100, the pickup 52 records the M test data onto the M sectors of the lead-out area of the CD 60 by emitting laser beams of a variety of power levels based on the optimal power Pₒₚₜ calculated in step 104. However, the method 100 can have step 104 omitted. In detail, the pickup 52 in step 106 can record the M test data onto the M sectors of the lead-out area of the CD 60 by emitting a variety of test powers not relating the optimal power Pₒₚₜ. For example, if M is equal to 15, a smallest test power of the test powers can be set to 60 mW, and a difference between any two consecutive test powers can be set to 6 mW according to an empirical rule.

In contrast to the prior art, the present invention can provide a method for determining a threshold write-in power by recording test data onto a lead-out area of a CD. A pickup can then record data onto a program area of the CD by emitting laser beams of a power less than the threshold write-in power reducing the chance of burning out the CD.

Those skilled in the art will readily observe that numerous modifications and alterations of the device and method may be made while retaining the teachings of the invention. Accordingly, the above disclosure should be construed as limited only by the metes and bounds of the appended claims.

1. A method for determining a threshold write-in power of a compact disc (CD), the method comprising:
recording M test data onto M sectors of an outer area of the CD with a pickup separately by emitting laser beams of a variety of distinct test powers;
reading the M test data of the M sectors with the pickup and calculating M corresponding error rates of the M test data; and
comparing the M error rates and therefore calculating the threshold write-in power, which is smaller than a smallest test power in an upper-bound test power set consisting of a plurality of test powers whose corresponding error rates are all larger than a threshold error rate, and is larger than a largest test power in a lower-bound test power set consisting of a plurality of test powers whose corresponding error rates are all smaller than the threshold error rate.

2. The method of claim 1, wherein the threshold error rate relates a decoding capacity of a processor to process the M test data.

3. The method of claim 1, wherein the M test data are the same.

4. The method of claim 1, wherein the M test data have one test data different from the remaining M−1 test data.

5. The method of claim 1, wherein the CD is a DVD+R.

6. The method of claim 1, wherein the error rate is a block error rate (BLER).

7. The method of claim 1, wherein the error rate is a DC jitter value.

8. The method of claim 1, wherein the outer area is located at the end of a program area of the CD.

9. The method of claim 1, wherein the outer area is located at a lead-out area of the CD.

10. The method of claim 1 further comprising:
executing an optimal power calibration (OPC) on a lead-in area of the CD and calculating an optimal power, which is smaller than all of the M test powers.

11. A device comprising a housing, a read/write pickup, a motorized spindle, a processor, and a logic unit for implementing the method of claim 1.

12. The method of claim 1 further comprising:
curve-fitting the M test powers based on a multi-degree polynomial whose independent variable is the error rate and whose dependent variable is the test power, the threshold write-in power equal to the dependent variable while the independent variable is equal to the threshold error rate.

13. A disc drive comprising:
a pickup for recording data onto a CD comprising an outer area and a program area;
a processor for calculating error rates corresponding the data recorded onto the CD; and
a logic unit for controlling the pickup to record data onto the CD by emitting laser beams of a variety of laser powers; for controlling the processor to calculate and to compare error rates corresponding to data recorded onto the CD; and for controlling the pickup not to record data onto the program area of the CD by emitting laser beams of a variety of laser powers smaller than a threshold write-in power until having controlled the pickup to record M test data onto M sectors of the outer area of the CD by emitting laser beams of a variety of distinct test powers and read the M test data of the M sectors, and having controlled the processor to calculate M corresponding error rates of the M test data, to compare the M error rates, and to calculate the threshold write-in power, which is smaller than a smallest test power in an upper-bound test power set consisting of a plurality of test powers whose corresponding error rates are all larger than a threshold error rate, and is larger than a largest test power in a lower-bound test power set consisting of a plurality of test powers whose corresponding error rates are all smaller than the threshold error rate.

14. The disc drive of claim 13, wherein the logic unit is a logic circuit.

15. The disc drive of claim 13, wherein the logic unit is a program code stored in a memory.

16. The disc drive of claim 13, wherein the threshold error rate relates a decoding capacity of the processor.

17. The disc drive of claim 13, wherein the error rate is a block error rate (BLER).

18. The disc drive of claim 13, wherein the error rate is a DC jitter value.

19. The disc drive of claim 13, wherein the CD further comprises a lead-in area, and the logic unit is capable of executing an OPC on the lead-in area of the CD and calculating an optimal power, which is smaller than all of the M test powers.

20. The disc drive of claim 13, wherein the outer area is located at the end of the program area of the CD.

21. The disc drive of claim 13, wherein the outer area is located at a lead-out area of the CD.
